(19) United States
(12) Patent Application Publication
(10) Pub. No.: US 2018/0025394 A1
(43) Pub. Date: Jan. 25, 2018

(54) QUALITATIVELY PLANNING, MEASURING, MAKING EFFICIENT AND CAPITALIZING ON MARKETING STRATEGY

(71) Applicant: ADI ANALYTICS LTD., Zur Moshe Village (IL)

(72) Inventor: Effi SHUV, Zur Moshe Village (IL)

(21) Appl. No.: 15/722,489

(22) Filed: Oct. 2, 2017

Related U.S. Application Data
(63) Continuation-in-part of application No. PCT/IL2015/050382, filed on Apr. 8, 2015.

(51) Int. Cl. G06Q 30/02; G06Q 10/06

(52) U.S. Cl. CPC G06Q 30/0282; G06Q 10/0639; G06Q 30/0202; G06Q 30/0242; G06Q 30/0201

(57) ABSTRACT

The present invention relates to a fully-automated method, in a data mining and data processing system, for defining and qualitatively planning, measuring, and making efficient Business Strategies and Marketing Strategies. The method comprising dynamically obtaining—by a data mining subsystem—information related to Business Strategy/Marketing Strategy; analyzing—by a data processing subsystem—said information, in real-time and offline, to identify patterns; selecting—by said data processing subsystem—relevant patterns from said identified patterns to define a Business Strategy/Marketing Strategy for a customer; and defining—by said data processing subsystem—a Business Strategy/Marketing Strategy based on said selected patterns and addressed to a specific brand—product or service—of a specific customer, which playing in a specific sector, of a specific country, at a specific time.

### FIELD OF THE INVENTION

The present invention relates to the field of Business Strategies and Marketing Strategies analyzing systems. More particularly, the invention relates to a fully-automated platform enabling vendors—of any sector and any size—to qualitatively plan, measure, make efficient, and capitalize on their Business Strategies and Marketing Strategies—ahead of time, before going air and spending any money.

### BACKGROUND OF THE INVENTION

Marketing is a hundreds-billion dollar global industry, and Marketing and Strategy managers are all making critical decisions with less data and discipline than they apply to negligible decisions in other aspects of their businesses. They are lack an industry standard for measurement. They need a method to determine the efficiency of their efforts. They need to measure how efficient their Business Strategies and Marketing Strategies at influencing purchase intent—the ultimate goal.

Hundreds of thousands of new products are launched to the market every year. The vast majority of new products fail within two years. And almost all of all innovations fail to return their cost of capital.

Enterprise vendors, manufacturers, suppliers, as well as governmental and national/public organizations are increasingly exploring the possibilities of reaching maximum end users, by dramatically increasing investments in Business Strategies and Marketing Strategies over a wide range of media, offline and online.

The technology is now available to do that. However, efficient measurability and human factor are vital elements for successful Business Strategies and Marketing Strategies, enabling the companies to capitalize on their investments.

The “Human Factor” may refer to the followings:
Highly considering the user experience in real time—providing the Business Strategies/Marketing Strategies managers with direct consideration of the end users' response, and having their immediate effect on the Business Strategies and Marketing Strategies results;
Measuring qualitative metrics—loyally, trust, passion, interaction, and brand awareness;
Measuring quantitative metrics—reach, volume of posts, conversations surround the brand, and influencers engagement;
Integrating Human Intuition, Expertise, and Usable Knowledge;
Interfacing with Social Media, enabling analysis of the social conversation surround a brand—Product, Solution, or Service;
Tracking new discoveries and insights—and constantly alerting accordingly;
Providing geo-locational, geographic, demographic, and psychographic insights—enabling full control over what is really relevant to the audience; and
Providing evidence-based insights.

Lack of a solution meeting the above unique and strict requirements may results in:
High costs of Business Strategies and Marketing Strategies;
Poor ROI (Return On Investment);
Negative impact on profitability; and
Customers dissatisfaction and high churn.

Typically, a Business Strategy/Marketing Strategy manager would need to perform an elaborated and time consuming analysis to figure out incremental gain in sales by increasing the respective Business and Marketing elements by one unit. In addition, the Business Strategy/Marketing Strategy manager would need to optimize the Business and Marketing resources—that is, budget, time, and headcount—and identify the efficient Business activities and Marketing activities.

Unfortunately, analyzing Business and Marketing data to determine Business Strategies and Marketing Strategies is extremely complex due to difficulties in capturing and extracting data from various data sources. Furthermore, business management often requires forecasting future outcomes of the sales/revenues based on changes in Business Strategies and Marketing Strategies including variations in spends towards various marketing channels. For any given business, there are a large number of factors that influence the business outcome. Many business organizations generate forecasts through a manual process, which can be extremely cumbersome and time-consuming.

Furthermore, since it is currently being done through a manually process—it never could be a valid and reliable one.

Therefore, it is desirable to develop a fully-automated platform to organize, integrate and analyze Business and Marketing data to generate valid and reliable Business Strategies and Marketing Strategies solutions for optimizing spend towards different marketing channels, different target markets, different geographies, different cultures, and at different economics climates.

It is an object of the present invention to provide a fully-automated platform which is capable of converting information and intelligence into key discoveries and actionable insights aligned with the customer's particular and evolving Business and Marketing needs.

It is another object of the present invention to provide a platform capable of providing evidence-based, actionable insights to essential Business questions and Marketing questions.

Other objects and advantages of the invention will become apparent as the description proceeds.

### SUMMARY OF THE INVENTION

The present invention relates to a fully-automated method, in a data mining and data processing system, for defining and qualitatively planning, measuring, and generating efficient Business Strategies and Marketing Strategies. The method comprising dynamically obtaining—by a data mining subsystem—information related to a Business Strategy/Marketing Strategy; analyzing—by a data processing subsystem—said information, in real-time and offline, to identify patterns; selecting—by said data processing subsystem—relevant patterns from said identified patterns to define a Business Strategy/Marketing Strategy for a customer; and defining—by said data processing subsystem—a Business Strategy/Marketing Strategy based on said selected patterns and addressed to a specific brand—Product, Solution, or Service—of a specific customer, which playing in a specific sector, of a specific country, at a specific time.

According to an embodiment of the invention, the method includes qualitatively measuring—ahead of time, before going air—the efficiency of Business Strategies and Marketing Strategies.

According to an embodiment of the invention, the method further comprises using validity and reliability analysis methods.

According to an embodiment of the invention, the method further comprises self-learning mechanism—enhancing both the Validity and Reliability of the system.

According to an embodiment of the invention, the method further comprises Post-Mortem analyzing—at the end of the generating process of the Business Strategy/Marketing Strategy of a specific sector—and amending the system predefined reference metrics of this sector accordingly.

According to an embodiment of the invention, the method further comprises integrating human intuition, expertise, and usable knowledge.

According to an embodiment of the invention, the method further comprises interfacing with social media, thereby enabling: analyzing the social conversation surround a Product/Solution/Service, measuring qualitative metrics—loyally, trust, passion, interaction, and brand awareness, and measuring quantitative metrics—reach, volume of posts, conversations surround the brand, and influencers engagement.

According to an embodiment of the invention, the method further comprises providing geo-locational, geographic, demographic, and psychographic insights—enabling full control over what is really relevant to the audience.

According to an embodiment of the invention, the method further comprises constantly alerting and updating—and automatically—the Business Strategy/Marketing Strategy managers about new discoveries and insights concerning their needs.

According to an embodiment of the invention, the method further comprises providing reactive decision making while the Business Strategy/Marketing Strategy is running, thereby enabling responding—across all channels—on-the-fly, changing/modifying the Business Strategy/Marketing Strategy in real time, and affecting the results accordingly.

According to an embodiment of the invention, the method further comprises providing evidence-based, actionable insights to essential business question.

The method of the present may enable the following features:
Capturing a 360 degree view around a Product, Solution, or Service;
Efficiency optimization of existing Business Strategies and Marketing Strategies;
Generic and High Longevity platform—well designed to meet particular and evolving customers' needs;
Cloud-Based Solution—dramatically saving CAPEX (CAPital EXpenses) and OPEX (Operational Expenses) costs;
Enabling Cross Business Strategy/Cross Marketing Strategy—a joint Business Strategy/Marketing Strategy of different Products/Solutions/Services addressed to the same target market concurrently.
Delivering the right message, at the right time, to the right audience, and by the right channels; and
Faster time to Business Insights and Marketing Insights.

According to an embodiment of the invention, obtaining information related to Business Strategy/Marketing Strategy further comprises: ensuring reliability and validating expected data metrics of a Business Strategy/Marketing Strategy—based on a self-learning mechanism—by examining their correlation with predefined reference metrics, and fine tuning these values accordingly, thereby ensuring that the current Business Strategy/Marketing Strategy is constantly valid, reliable, efficient and qualitative measurability.

According to an embodiment of the invention, further comprises applying artificial intelligent algorithms on the fine-tuned data—as part of the self-learning mechanism—thereby providing valid and reliable strategic.

According to an embodiment of the invention, obtaining information related to Business Strategy/Marketing Strategy comprises: performing data mining operations to collect customer interaction information from a plurality of sources—both in real-time (online) and offline.

According to an embodiment of the invention, the data mining operations comprise data retrieval form external sources including social media and professional databases.

According to an embodiment of the invention, the customer interactions comprise at least one of a brand—product or service—review, a review comment, a post, a comment, various types of digital feedbacks, or interconnected documents and other digital conversations.

According to an embodiment of the invention, analyzing the information to identify patterns comprises: identifying parameters based on their current values and computing foreseen values of these parameters, and accordingly providing relevant trends—business, commercial, trade, geo-locational, geographic, demographic, and psychographic—both domestic and international, that may affect the Business Strategy/Marketing Strategy.

According to an embodiment of the invention, analyzing the information to identify patterns further comprises: analyzing the parameters at the end of the generating process of the Business Strategy/Marketing Strategy of a specific sector and amending the system predefined reference metrics of this sector accordingly—as known as Post-Mortem Analysis, thereby ensuring validity and reliability.

According to an embodiment of the invention, analyzing the information to identify patterns comprises: qualitatively and efficiently identifying a set of influencing parameters, wherein the set of influencing parameters is used by a vendor to define Business Strategies and Marketing Strategies for a set of customers.

According to an embodiment of the invention, the method further comprises allowing the integration of human intuition, expertise, and usable knowledge, and accordingly providing most up-to-date, valid, and reliable Business Strategies and Marketing Strategies.

According to an embodiment of the invention, the method further comprises creating evidence-based, actionable insights to essential Business questions and Marketing questions, by the data processing and data mining.

According to an embodiment of the invention, the creation of the actionable insights includes one or more of: fully-automated and continually gathering information from many sources—both in real time and offline, capturing a 360 degree view around the Product/Solution/Service, monitoring the social conversation surround the Product/Solution/Service, filtering the top relevant information only, identifying hidden patterns—by analyzing huge amount of information and intelligence, and over long time, in-depth, competitive analysis, continually analyzing/reanalyzing the information, and comparing the results to the real world—ensuring the system is always valid and reliable, micro-assessment of strengths, weaknesses, opportunities, an threats, identifying and alerting vulnerabilities, identifying and alerting edge advantages, minimizing risks and maximizing opportunities by early discovering and alerting, Reactive Decision Making, Post-Mortem analysis—enhancing the validity and reliability of the system, cross-checking with insights generated for other analysis of the same sector and/or country—enhancing the validity and reliability of the system.

According to an embodiment of the invention, the method further comprises providing an operational Reactive Decision Making module while the Business Strategy/Marketing Strategy is running, thereby enabling responding—across all channels—on-the-fly, changing/modifying the Business Strategy/Marketing Strategy in real time, and affecting the results accordingly.

According to an embodiment of the invention, fully-automatically and qualitatively defining a Business Strategy/Marketing Strategy based on the selected patterns comprises: dynamically identifying at least one of channels associated with a segment of brands either Products, Solutions, or Services; identifying Business Strategies and Marketing Strategies of a vendor associated with a segment of brands based on current business, commercial, trade, geo-locational, geographic, demographic, and psychographic factors that are associated with a customer and a most efficient channel to reach the customer for the segment of said brands; and presenting to a client associated with a customer, a set of Business Strategies and Marketing Strategies defined by a vendor for the segment of said brands as a ranked list.

In another aspect, the present invention relates to a system, which comprises: at least one processor; and a memory comprising computer-readable instructions which when executed by the at least one processor causes the processor to execute a data processing system for defining and qualitatively measuring Business Strategies and Marketing Strategies, wherein the system:
dynamically obtains—by a data mining subsystem—information related to a Business Strategy/Marketing Strategy;
analyzes—by a data processing subsystem—said information, in real-time and offline, to identify patterns;
selects—by said data processing subsystem—relevant patterns from said identified patterns to define a Business Strategy/Marketing Strategy for a customer; and
defines—by said data processing subsystem—a Business Strategy/Marketing Strategy based on said selected patterns and addressed to a specific brand—Product, Solution, or Service—of a specific customer, which playing in a specific sector, of a specific country, at a specific time.

In another aspect, a non-transitory computer-readable medium comprising instructions which when executed by at least one processor causes the processor to perform the fully-automated method, in a data mining and data processing system, of defining and qualitatively planning, measuring, and making efficient Business Strategies and Marketing Strategies.

### BRIEF DESCRIPTION OF THE DRAWINGS

In the drawings:

FIG. 1 schematically illustrates a high-level architecture of a system for fully-automated and qualitatively planning, measuring, making efficient and capitalizing on Business Strategies and Marketing Strategies, according to an embodiment of the invention;

FIG. 2 schematically illustrates central analysis database architecture, according to an embodiment of the invention;

FIG. 3 schematically illustrates a Universal Macro Metrics Database (UMMD), according to an embodiment of the invention;

FIG. 4 schematically illustrates a Sectorial Micro Metrics Database (SMMD), according to an embodiment of the invention;

FIG. 5 schematically illustrates a Customer Social Media Metrics Database (CSMM), according to an embodiment of the invention;

FIG. 6 schematically illustrates a Customer Nano Metrics Database (CNMD), according to an embodiment of the invention; and

FIG. 7 schematically illustrates the system's layers, according to an embodiment of the invention.

### DETAILED DESCRIPTION OF THE INVENTION

The term “data processing” refers herein to the tasks of: gathering massive amount of data (the data can be of many types and formats, and from many different sources) both in real time and offline; transforming this data into ‘legible’, ‘understood’, usable, and accessible items; and ultimately organizing this data in a pre-defined databases. Following the data processing stage, there is usually too much ‘data’, but not enough ‘information’. Therefore, the next stage of data mining is required.

In this context, the term “data mining” refers to herein to the tasks of performing a series of powerful analysis tools on this processed data—identifying hidden patterns, and ultimately converting this information and intelligence into key discoveries, actionable insights, and predicted behavior.

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

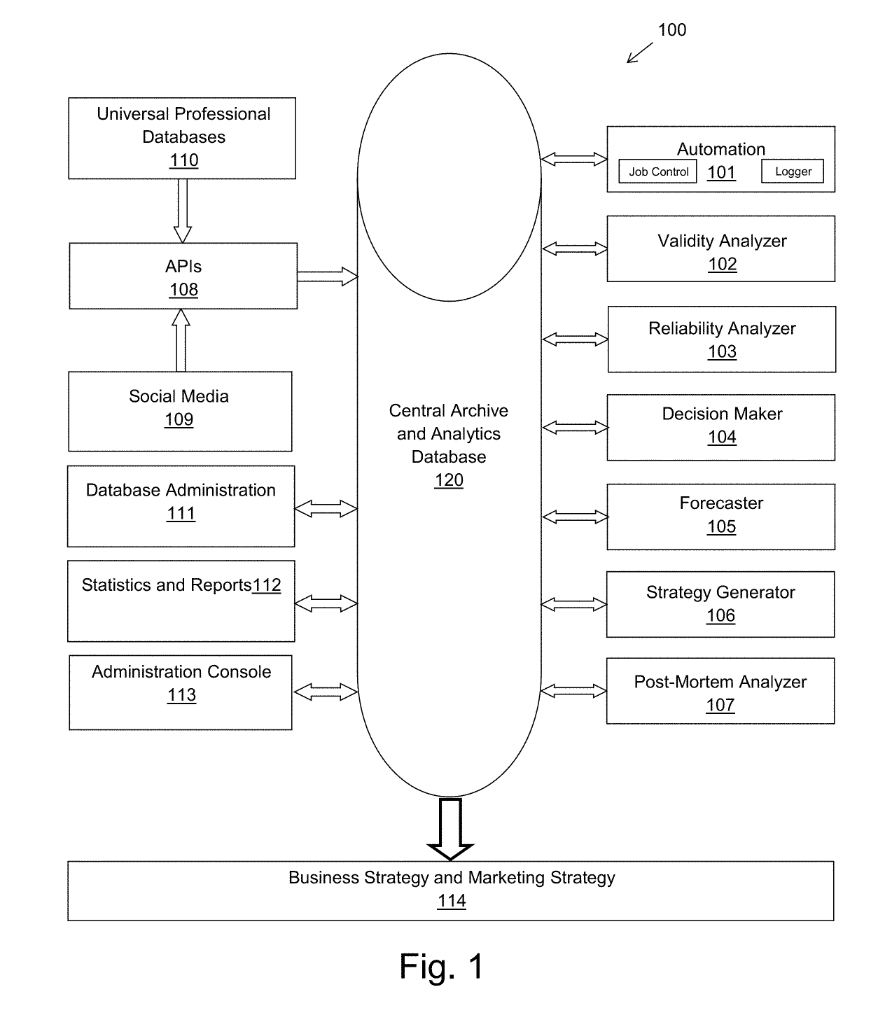

FIG. 1 schematically illustrates a high-level architecture of a system 100 for fully-automated and qualitatively planning, measuring, making efficient and capitalizing on Business Strategies and Marketing Strategies, according to an embodiment of the invention. System 100 comprises a Central Archive and Analysis Database (CAAD) 120, and plurality of subsystem modules 101-113 that communicates with CAAD 120, such as Automation 101, Validity Analyzer 102, Reliability Analyzer 103, Decision Maker 104, Forecaster 105, Strategy Generator 106, Post-Mortem Analyzer 107, Application Programming Interface (API) 108 for handling third party data from external sources such as Social Media 109 and Professional Databases 110, Database Administration 111, Statistics and Reports 112, and Administration Console 113. CAAD 120 process and analyzes the data (i.e., performs data processing and data mining) from the subsystem modules and accordingly outputs Business Strategy and Marketing Strategy 114.

CAAD 120 is a Relational Data Base Management System (RDBMS) containing all the relevant information—static and dynamic (those changing over time)—about all the Business Strategies and Marketing Strategies, previous and currently running. CAAD 120 is the basis for working of all the other subsystems within system 100.

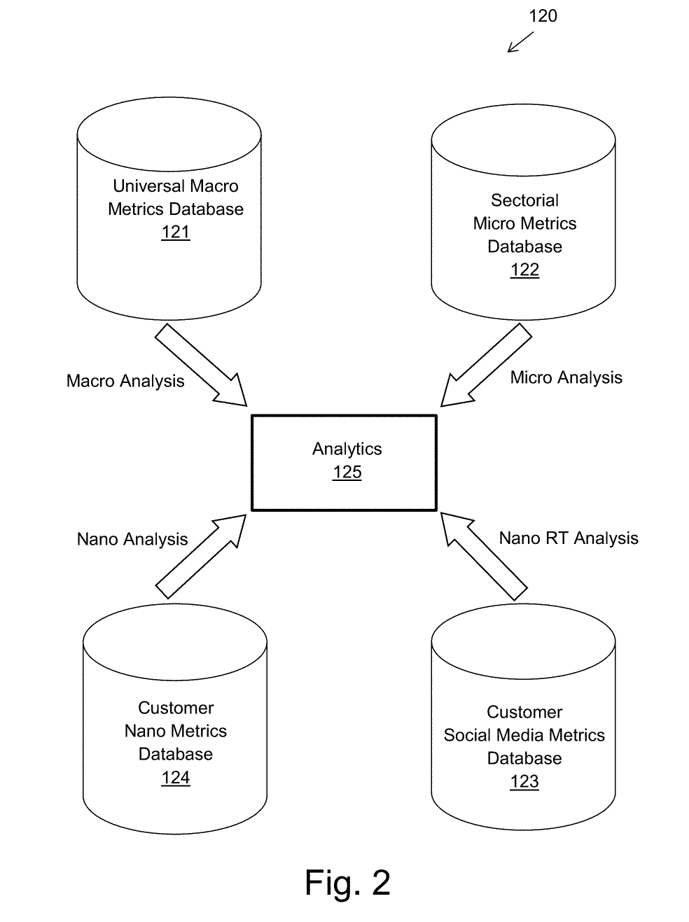

Referring now to FIG. 2, an exemplary CAAD 120 architecture is shown in accordance with an embodiment of the invention. According to this exemplary embodiment, CAAD 120 may contain the following databases:
Universal Macro Metrics Database (UMMD) 121;
Sectorial Micro Metrics Database (SMMD) 122;
Customer Social Media Metrics Database (CSMM) 123; and
Customer Nano Metrics Database (CNMD) 124.

Where analytics 125 is adapted to handle the data stored in the databases 121-124. 125 is representing all the analyzing subsystems, that is, 102, 103, 104, 104, 105, 106, and 107.

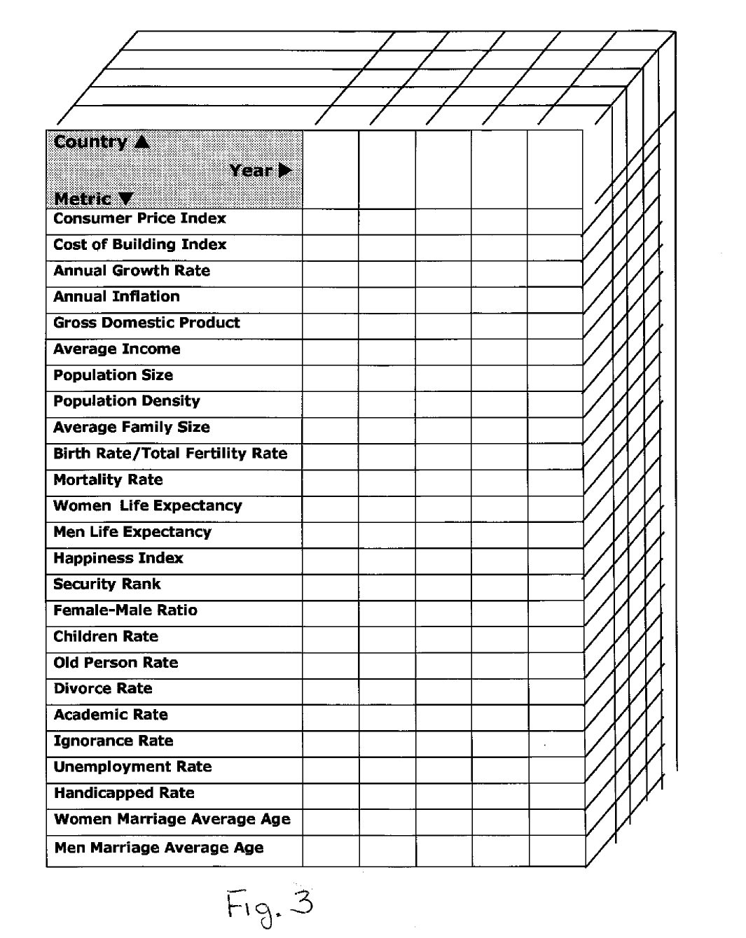

FIG. 3 schematically illustrates a 3-dimenal matrix the outlines the UMMD 121, according to an embodiment of the invention. UMMD 121 may include data representing Country-Related information such as Consumer Price Index, Cost of Building Index, Annual Growth Rate, Annual Inflation, Gross Domestic Product, Average Income, Population Size, Population Density, Average Family Size, Birth Rate, etc.

The following Table 1 outlines an exemplary data type of different fields that may be included in UMMD 121:

TABLE 1

| Field | Data Type |
|---|---|
| Consumer Price Index | Decimal (x.y) |
| Cost of Building Index | Decimal (x.y) |
| Annual Growth Rate | Decimal (x.yz %) |
| Annual Inflation | Decimal (x.yz %) |
| Gross Domestic Product | Integer |
| Average Income | Integer |
| Population Size | Integer |
| Population Density | Decimal (x.yz %) |
| Average Family Size | Decimal (x.yz) |
| Birth Rate | Decimal (x.yz %) |
| Total Fertility Rate | Decimal (x.yz) |
| Mortality Rate | Decimal (x/100) |
| Women Life Expectancy | Decimal (x.y) |
| Men Life Expectancy | Decimal (x.y) |
| Happiness Index | Integer |
| Security Rank | Integer |
| Female-Male Ratio | Decimal (x.y %) |
| Children Rate | Decimal (x.y %) |
| Old Person Rate | Decimal (x.y %) |
| Divorce Rate | Decimal (x.y) |
| Academic Rate | Decimal (x.y %) |
| Ignorance Rate | Decimal (x.y %) |
| Unemployment Rate | Decimal (x.y %) |
| Handicapped Rate | Decimal (x.y %) |
| Women Marriage Average Age | Decimal (x.y) |
| Men Marriage Average Age | Decimal (x.yz) |

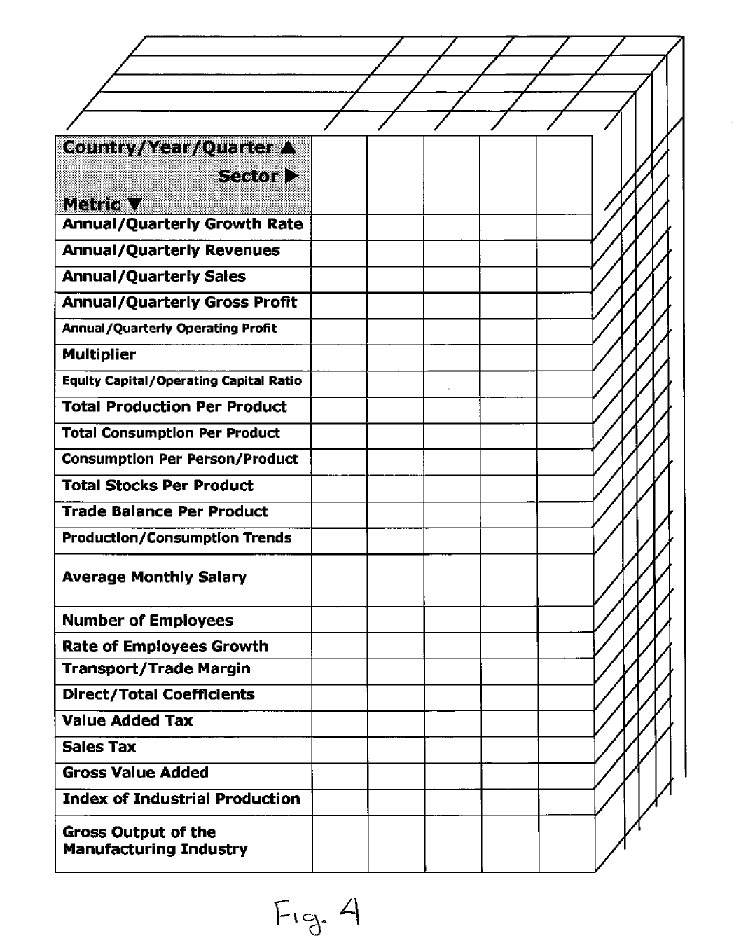

FIG. 4 schematically illustrates a 5-dimenal matrix the outlines the SMMD 122, according to an embodiment of the invention. SMMD 122 may include data representing Sector-Related information such as Annual/Quarterly Growth Rate, Annual/Quarterly Revenues, Annual/Quarterly Sales, Annual/Quarterly Gross Profit, Annual/Quarterly Operating Profit, Multiplier, Equity Capital/Operating Capital Ratio, Total Production Per Product, Consumption Per Product, Consumption Per Person/Product, Total Stocks Per Product, Trade Balance Per Product, Production Trends, Consumption Trends, etc.

The following Table 2 outlines an exemplary data type of different fields that may be included in SMMD 122:

TABLE 2

| Field | Data Type |
|---|---|
| Annual Growth Rate | Decimal (x.yz %) |
| Quarterly Growth Rate | Decimal (x.yz % × Q1/Q2/Q3/Q4) |
| Annual Revenues | Integer |
| Quarterly Revenues | Integer (×Q1/Q2/Q3/Q4) |
| Annual Sales | Integer |
| Quarterly Sales | Integer (×Q1/Q2/Q3/Q4) |
| Annual Gross Profit | Integer |
| Quarterly Gross Profit | Integer (×Q1/Q2/Q3/Q4) |
| Annual Operating Profit | Integer |
| Quarterly Operating Profit | Integer (×Q1/Q2/Q3/Q4) |
| Multiplier | Decimal (x.y) |
| Equity Capital/Operating Capital | Decimal (x.yz) |
| Ratio | |
| Total Production Per Product | Integer |
| Total Consumption Per Product | Integer |
| Consumption Per Person/Product | Decimal (x.yz) |
| Total Stocks Per Product | Integer |
| Trade Balance Per Product | Integer |
| Production Trends | Text |
| Consumption Trends | Text |
| Average Monthly Salary | Integer |
| Number of Employees | Integer |
| Rate of Employees Growth | Decimal (x.y %) |
| Transport Margin | Integer |
| Trade Margin | Integer |
| Direct Coefficients | Decimal (x.yz %) |
| Total Coefficients | Decimal (x.yz %) |
| Value Added Tax | Decimal (x.y %) |
| Sales Tax | Decimal (x.y %) |
| Gross Value Added | Integer |
| Index of Industrial Production | Decimal (x.y) |
| Gross Output of the | Integer |
| Manufacturing Industry | |

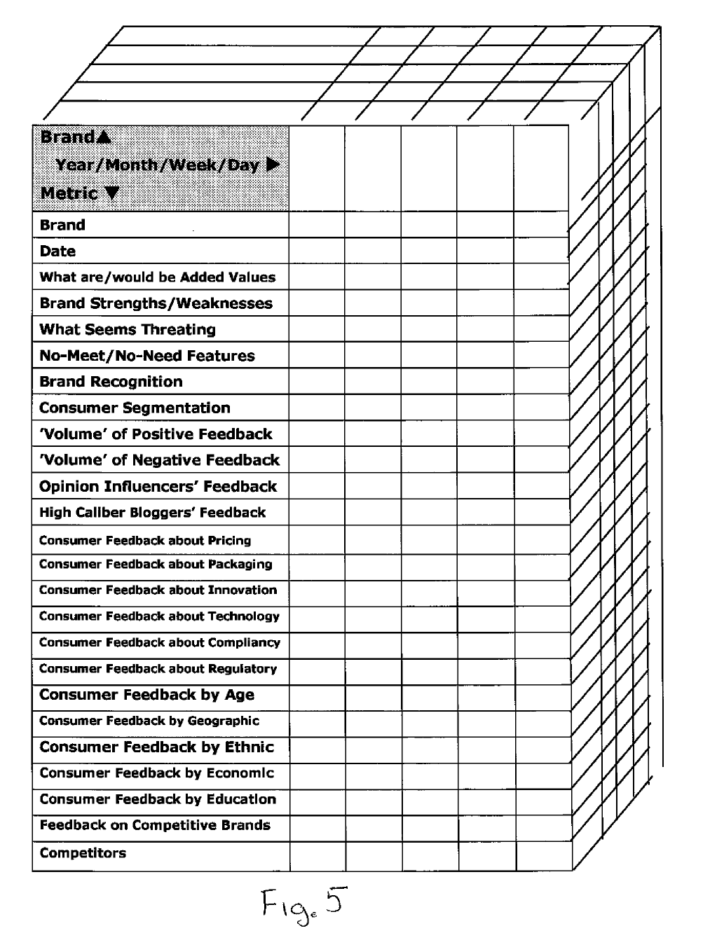

FIG. 5 schematically illustrates a 6-dimenal matrix the outlines the CSMM 123, according to an embodiment of the invention. CSMM 123 may include data representing Social Media Related information such as What are the Added Values, What would be Added Values, Brand Strengths, Brand Weaknesses, What Seems Threating, No-Meet Needs, No-Meet Features, Brand Recognition, Consumer Segmentation, ‘Volume’ of Positive/Negative Feedback, Opinion Influencers' Feedback, High Caliber Bloggers' Feedback, etc.

The following Table 3 outlines an exemplary data type of different fields that may be included in CSMM 123:

TABLE 3

| Field | Data Type |
|---|---|
| Brand | Text |
| Date | DDMMYYYY |
| What are the Added Values | Text List-By Priority |
| What would be Added Values | Text List-By Priority |
| Brand Strengths | Text List-By Priority |
| Brand Weaknesses | Text List-By Priority |
| What Seems Threating | Text List-By Priority |
| No-Meet Needs | Text List-By Priority |
| No-Need Features | Text List-By Priority |
| Brand Recognition | Text List |
| Consumer Segmentation | Text Table |
| ’Volume’ of Positive Feedback | Integer |
| ’Volume’ of Negative Feedback | Integer |
| Opinion Influencers' Feedback | Text List |
| High Caliber Bloggers' Feedback | Text List |
| Consumer Feedback about Pricing | Text List |
| Consumer Feedback about Packaging | Text List |
| Consumer Feedback about Innovation | Text List |
| Consumer Feedback about Technology | Text List |
| Consumer Feedback about Compliancy | Text List |
| Consumer Feedback about Regulatory | Text List |
| Consumer Feedback by Age | Text Table |
| Consumer Feedback by Geographic | Text Table |
| Consumer Feedback by Ethnic | Text Table |
| Consumer Feedback by Economic | Text Table |
| Consumer Feedback by Education | Text Table |
| Feedback on Competitive Brands | Text List |
| Competitors | Table: All the above |
| | fields about each |
| | competitor |

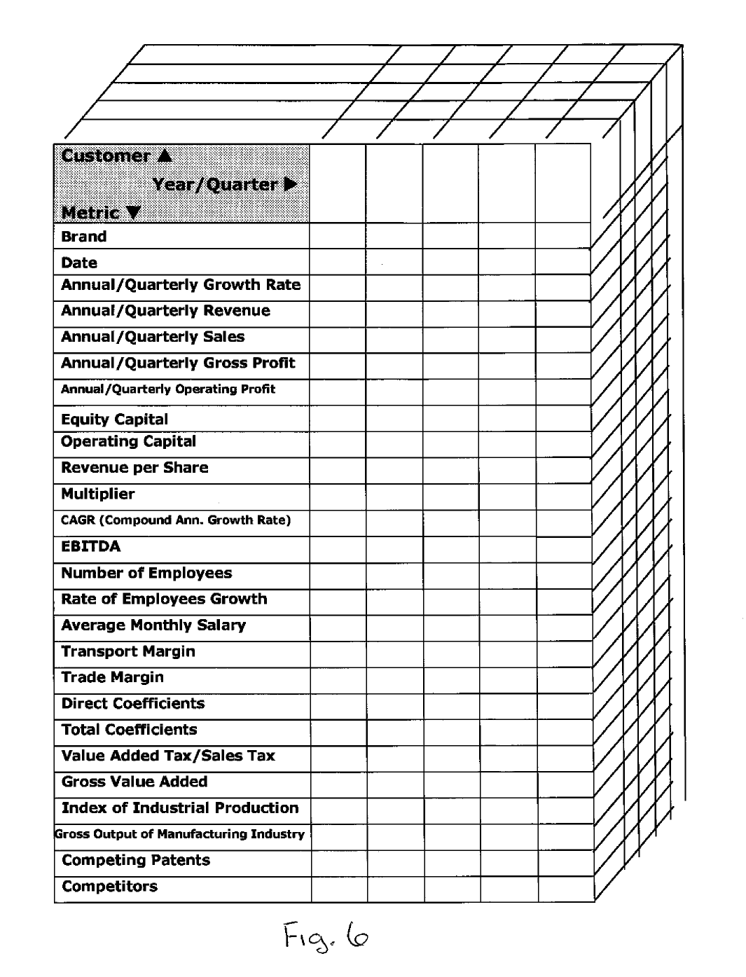

FIG. 6 schematically illustrates a 4-dimenal matrix the outlines the CNMD 124, according to an embodiment of the invention. CNMD 124 may include data representing Customer-Related information such as Annual/Quarterly Growth Rate, Annual/Quarterly Revenues, Annual/Quarterly Sales, Annual/Quarterly Gross Profit, Annual/Quarterly Operating Profit, Equity Capital, Operating Capital, Revenue per Share, Multiplier, CAGR (Compound Annual Growth Rate), EBITDA (Earning Before Interest, Tax, Depreciation and Amortization), etc.

The following Table 4 outlines an exemplary data type of different fields that may be included in CNMD 124:

TABLE 4

| Field | Data Type |
|---|---|
| Brand | Text |
| Date | DDMMYYYY |
| Annual/Quarterly Growth Rate | Decimal (x yz % × Q1/Q2/Q3/Q4) |
| Annual Revenue | Integer |
| Quarterly Revenue | Integer (×Q1/Q2/Q3/Q4) |
| Annual Sales | Integer |
| Quarterly Sales | Integer (×Q1/Q2/Q3/Q4) |
| Annual Gross Profit | Integer |
| Quarterly Gross Profit | Integer (×Q1/Q2/Q3/Q4) |
| Annual Operating Profit | Integer |
| Quarterly Operating Profit | Integer (×Q1/Q2/Q3/Q4) |
| Equity Capital | Integer |
| Operating Capital | Integer |
| Revenue per Share | Integer |
| Multiplier | Decimal (x.y %) |
| CAGR | Decimal (x.yz %) |
| (Compound Annual Growth Rate) | |
| EBITDA | Integer |
| Number of Employees | Integer |
| Rate of Employees Growth | Decimal (x.z %) |
| Average Monthly Salary | Integer |
| Transport Margin | Integer |
| Trade Margin | Integer |
| Direct Coefficients | Decimal (x.yz %) |
| Total Coefficients | Decimal (x.yz %) |
| Value Added Tax | Decimal (x.y %) |
| Sales Tax | Decimal (x.y %) |
| Gross Value Added | Integer |
| Index of Industrial Production | Decimal (x.y) |
| Gross Output of the Manufacturing | Integer |
| Industry | |
| Competing Patents | IP related data such as indicated |
| | in Table 5 |
| Competitors | Table: All the above fields about |
| | each competitor-except of |
| | Competing Patents |

An exemplary IP related data is shown by following Table 5:

TABLE 5

| | | | | | Full |
|---|---|---|---|---|---|
| Brand | Country | Patent ID | Subject | Synopsis | Description |
| Text | Text | Alpha-Numeric | Text | Text | URL |

The following provides descriptions of the subsystem modules that work with CAAD 120 in order to provide a suitable computing environment in which the invention may be implemented. While the invention will be described in the general context of program modules that execute in conjunction with an application program that runs on an operating system on a computer system, those skilled in the art will recognize that the invention may also be implemented in combination with other subsystem modules.

### Database Administration

Database Administration 111 keeps all the databases within system 100—that is, the UMMD 121, SMMD 122, CNMD 123, and CSMM 124—updated, consistent, and complete—using various tools, like:
Editors—Graphical software enabling intuitive insertion, deletion, modification, and visualization of formatted data of various types like text, graphics, audio, video, etc.
Events Manager—A software module that allows performing basic tasks with databases, like Create, Delete, Update, Insert, Open, Save, Alert, Drop, Logon, Logoff, Startup, Shutdown, etc., as well as accessing records and fields within a database.
Triggers Manager—A software module maintaining the integrity of the information on the databases, by containing stored procedures that configured to automatically execute in response to certain events take place on particular table or view in a database.

### Automation 101

Automation 101 module I controlling the Full Automation of the entire system, using 3 sub-modules:
Automation Control
   Controlling the following functions:
   Job Control Frequency
   Stop Automation
   Resume Automation
Job Control
Controlling the following functions:
   Exactly which Job shall be executed
   When
   Exactly which Process shall be executed by this Job
Logger
Logging, in real time, the entire system activities—for multiple purposes:
   Further Analysis
   Quality Assurance
   Debugging

### Validity Analyzer

The Validity Analyzer 102 module validates the expected metrics of a Business Strategy/Marketing Strategy by examining their correlation with predefined reference metrics of system 100, and fine tuning these values accordingly. In Addition, it ensures that the current Business Strategy/Marketing Strategy is constantly Valid—and notifying the Decision Maker module accordingly.

The Validity Analyzer is applied to both Analysis Design and Analysis Methods of the analytics platform—making sure that the system is measuring what it's intended to measure, and its findings are truly representing the phenomenon and patterns the platform is claiming to measure.

The Validity Analyzer provides an indication of how solid the claimed Business Strategies and Marketing Strategies are.

The Validity Analyzer ensures, among others, that the expected metrics of a Business Strategy/Marketing Strategy—by examining their correlation with the system predefined reference metrics, fine tuning these values accordingly, and notifying the Decision Maker module accordingly.

The Self-Learning module—which is one of the core elements in the platform—is enhancing in turn the Validity of the analytics system

### Reliability Analyzer

The Reliability Analyzer 103 validates the expected metrics of a Business Strategy/Marketing Strategy by examining their correlation with predefined reference metrics of system 100, and fine tuning these values accordingly. In Addition, it ensures that the current Business Strategy/Marketing Strategy is constantly Reliable—and notifying the Decision Maker module accordingly.

The Reliability Analyzer is applied to both Analysis Design and Analysis Methods of the analytics platform—making sure that the system is generating the same results under the same conditions.

The Reliability Analyzer provides an indication about the quality of the measurement methods used to generate the claimed Business Strategies and Marketing Strategies.

Reliability is ensured by observing the overall consistency, repeatability, and stability of the various measures/metrics and checking if they produce similar results under consistent conditions.

The Self-Learning module—which is one of the core elements in the platform—is enhancing in turn the Reliability of the analytics system. One of the core elements of system 100 is a Self-Learning mechanism which used to enhance both the Validity and Reliability of the system.

According to an embodiment of the invention, the reference metrics can be a pre-modeling marketing data having a plurality of Business variables and Marketing variables, wherein each of the plurality of Business variables and Marketing variables associated with Business Strategies and Marketing Strategies for one or more Products/Solutions/Services. Examples of the Business variables and Marketing variables include, but are not limited to, sales data captured over a period of time for products, parameters indicating the time/season of the year, macroeconomic parameters such as total income of individuals in a selected market region. It would be appreciated by those skilled in the art that a variety of such Business parameters and Marketing parameters may be envisaged.

### Decision Maker

Decision Maker 104 provides critical business, strategic, marketing, and operational reactive decision making, based on Artificial Intelligence (AI) methodologies—such as improving go-to-market plan, hit market faster, marketing plan reassessment, pricing strategy reassessment, sales plan reassessment, sales force effectiveness, etc.—in the course of an active Business Strategy/Marketing Strategy—according to the results of Validity Analyzer 102 and Reliability Analyzer 103.

The Decision Maker module 104 enables the customer to respond across all channels on-the-fly, in real time—while the Business Strategy/Marketing Strategy is running—and affecting the results accordingly, by changing/modifying the Business Strategy/Marketing Strategy.

### Forecaster

Forecaster 105 based on present values of various parameters—such as sales, consumer segmentation by various breakdowns, pricing, etc., Forecaster 105 computes the foreseen values of these parameters, and accordingly provides relevant trends, both domestic and international, that may affect the Business Strategy/Marketing Strategy.

### Strategy Generator

Strategy Generator 106 analyzes on-line the entire Business Strategy/Marketing Strategy for providing results at each single criteria of a Business Strategy/Marketing Strategy, such as brand—Product, Solution, or Service—perception, brand strengths and weaknesses, key opinion leader mapping, market's real needs and unaddressed consumers' needs, competitive intelligence (competitor and brand mapping, pricing, perception, strengths, weaknesses, innovation, technologies), competitors' reaction (offering, pricing, packaging, reactive campaigns, etc.), market maturity indicators, market key drives and challenges, market disruptive trends, regulatory and compliancy indicators, technology landscape, innovation threats, IP (Intellectual Property) strengths and weaknesses, most attractive target markets, new opportunities, competitive brand positioning, best offering, most recommended business/strategic partnerships, etc.

### Post-Mortem Analyzer

Post-Mortem Analyzer 107 performs offline comprehensive and in-depth analysis—at the end of the generating process of the Business Strategy/Marketing Strategy of a specific sector—and accordingly amends the system predefined reference metrics of this sector:
Correlation—calculating the correlation between the expected metrics and the system predefined reference metrics;
Sectorial Standard Deviation—calculating the difference between the expected metrics and the system predefined reference metrics, relative to this difference in all the other Business Strategies/Marketing Strategies of the same sector;
Global Standard Deviation—calculating the difference between the expected metrics and the system predefined reference metrics, relative to this difference in all the other Business Strategies/Marketing Strategies of all the sectors;
Trends Identification;
Non-Trivial Patterns—analyzing those patterns which need long time of observation and follow-up in order to conclude insights accordingly—such as phenomena happen only at a specific day in a month/week, or at a specific hour in a day, or at a specific geography, or for a very specific gender, etc.
Exploring the reasons for the above mentions correlation and standard deviations, according to variety of terms such as:
   Business Strategy/Marketing Strategy launch time (e.g., month during the year, season during the year, any other special event during the year, etc.);
   Marketing Media Channels (e.g., Resellers, Retailers, Point of Sales, Television, Cinema, Print media, Interactive Billboard, Social Networks, IVR [Interactive Voice Response]);
   Time Amount of Exposure to a Brand (Product, Solution, or Service);
   Socio-Economic Breakdowns;
   Demographic Profile (e.g., Place of Living such as City/Town/Village, North/East/South/West, etc.);
   Income Level;
   Education Degree (e.g., Basic School/High School/Academy, etc.), Gender (Female/Male);
   Marital Status (e.g., Single/Married/Divorced/Widow);
      and the like.

### APIs

APIs 108 recognizes that every third party vendor has its own unique process and workflow requirements—this subsystem contains a set of open and fully standards compliant APIs (Application Programming Interface) providing the modularity to build a highly flexible best-in-class ecosystem.

This module may contain APIs with the following third party subsystems:
Professional Databases 110, such as IP (Intellectual Properties), Trade, Finance, Governance, Academic Researches Publications, Regulatory
A Social Media API module 109 that transforms multiple unclassified social online data—which is proven to be an ultimate source for intelligence—into purposeful intelligence findings:
   Measuring qualitative metrics—loyalty, trust, passion, interaction, and brand awareness
   Measuring quantitative metrics—reach, volume of posts, conversations surround the brand, and influencers engagement

The Social Media API module 109 gathers data that can be collected from a wide range of available web-based sources such as social networks, news publications, magazines, high-caliber blogs, consumer discussions, career websites, etc. Interfacing with Social Media 109 enables to provide an analysis of the social conversation surround a product or service.

### Administration Console

Administration Console 111 is software based application that provides a powerful graphical tool, which may enable the following:
Setting/Modifying of system predefined reference metrics (Super User);
Setting/Modifying of expected metrics given by the customer;
Setting/Modifying of the weight of each taking part metric.

In addition, the Administration Console 111 provides an intuitive data visualization, in various breakdowns, that is easy to interpret and easy to act on—giving insights into the hearth of the system at variety of aspects, such as:
Multi-Level (e.g., specific marketing media, a group of marketing media, entire Business Strategy/Marketing Strategy life);
Multi-Period (e.g., Daily/Weekly/Monthly/Quarterly, entire Business Strategy/Marketing Strategy period, user defined);
Multi-Format (e.g., table, pie chart, bar chart, graph).

### Statistics and Reports 112

Statistics and Reports 112 module is providing an intuitive data visualization, in various breakdowns that is easy to interpret and easy to act on, and enabling to make powerful strategic, business, and operational decisions—by giving insights into the hearth of the system at:

Multi Level
Specific marketing media
A group of marketing media
Entire Business Strategy life
Entire Marketing Strategy life

Multi Period
Daily/Weekly/Monthly/Quarterly
Entire Business Strategy period
Entire Marketing Strategy period
User Defined

Multi Format
Table
2D/3D Pie Chart
2D/3D Bar Chart
2D/3D Graph

### Administration Console 113

Administration Console 113 module is a software based application providing a powerful graphical tool, enabling the following:
Setting/Modifying of system predefined reference metrics (Super User)
Setting/Modifying of expected metrics given by the customer
Setting/Modifying of the weight of each taking part metric

### Business Strategies and Marketing Strategies

The Business Strategies and Marketing Strategies module 114 provides intuitive insights visualization that is easy to interpret and easy to act on—addressing a wide range of highly valuable Business missions and Marketing missions:
Insights about current situation:
   Brand—Product, Solution, or Service—Perception
   Brand Strengths and Weaknesses
   Key Opinion Leader Mapping
   Market's Real Needs and Unaddressed Consumers' Needs
   Competitive Intelligence (e.g., Competitor and Brand Mapping, Pricing, Perception, Strengths, Weaknesses, Innovation, Technologies)
   Competitors' Reaction (Offering, Pricing, Packaging, etc.)
   Market Maturity Indicators
   Market Key Drives and Challenges
   Market Disruptive Trends
   Regulatory and Compliancy Indicators
   Technology Landscape/Innovation Threats
   IP Strengths and Weaknesses
   Market Maturity Indicators
   Market Key Drives and Challenges
   Market Trends
   Regulatory and Compliancy Indicators
   Technology Landscape/Innovation Threats
   IP Strengths and Weaknesses
Insights on Recommended Business Strategy/Marketing Strategy:
   Most Attractive Target Markets
   Most Attractive Target Markets
   New Opportunities
   Competitive Brand Positioning
   Best Offering
   Improving Go-To-Market Plan and Hit Market Faster
   Business Plan Reassessment
   Marketing Plan Reassessment
   Pricing Strategy Reassessment
   Sales Plan Reassessment
   Sales Force Effectiveness
   Most Recommended Business/Strategic Partnerships

Such insights enable maximizing the ROI (Return On Investment), capitalizing on marketing costs, by allowing system 100 to deliver the right message, at the right time, to the right audience, and by the right channels.

The Business Strategies and Marketing Strategies module 114 may provide its outcomes in various breakdowns:
Specific Country;
A Group of Countries (e.g., EU [European Union], OECD [Organization for Economic Co-operation and Development], BRICS [Brazil, Russia, India, China, South Africa)], Developed Countries, Developing Countries, Worldwide);
Specific Brand (Product, Solution, or Service);
A Group of Brands (Products, Solutions, or Services);
At Firm Level.

CAAD 120 and the subsystems modules of system 100 are implemented by program modules that may include routines, programs, components, data structures, and other types of structures that perform particular tasks or implement particular abstract data types in system 100. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the invention may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

Although the functions described hereinabove may be performed by executable code and instructions stored in computer readable medium and running on one or more processor-based systems. However, state machines, and/or hardwired electronic circuits can also be utilized. Further, with respect to the example processes described hereinabove, not all the process states need to be reached, nor do the states have to be performed in the illustrated order. Further, certain process states that are illustrated as being serially performed can be performed in parallel.

FIG. 7 schematically illustrates system 100 is a top level layer form, according to an embodiment of the invention. The layer form includes a data storage layer 73 that performs data mining using CAAD 120, a business logic layer 72 that perform data processing and a presentation layer 71 that provides the data to the user.

The terms, “for example”, “e.g.”, “optionally”, as used herein, are intended to be used to introduce non-limiting examples. While certain references are made to certain example system subsystem modules or services, other subsystem modules and services can be used as well and/or the example subsystem modules can be combined into fewer components and/or divided into further components.

As will be appreciated by the skilled person the embodiments described hereinabove results in a cloud-based platform that converts information and intelligence into key discoveries and actionable insights aligned with the customer's current and evolving Business and Marketing needs. Moreover it provides unique methodologies of research and intelligence analysis by automatically collecting diverse signals from various—static and dynamic—sources, then modeling, and integrating Human Intuition, expertise, and usable knowledge, thereby providing evidence-based, actionable insights to essential business questions.

All the above description and examples have been given for the purpose of illustration and are not intended to limit the invention in any way. Many different mechanisms, methods of analysis and subsystem modules can be employed, all without exceeding the scope of the invention.

1. A fully-automated method, in a data processing system, for defining and qualitatively measuring Business Strategies and Marketing Strategies, the method comprising:
a) dynamically obtaining—by a data mining subsystem—information related to Business Strategies and Marketing Strategies;
b) analyzing—by a data processing subsystem—said information, in real-time and offline, to identify patterns;
c) selecting—by said data processing subsystem—relevant patterns from said identified patterns to define Business Strategy and Marketing Strategy for a customer and converting said patterns into key discoveries, actionable insights, and predicted behavior; and
d) defining—by said data processing subsystem—Business Strategy and Marketing Strategy based on said selected patterns and addressed to a specific brand—Product, Solution, or Service—of a specific customer, which playing in a specific sector, of a specific country, at a specific time.

2. The method according to claim 1, wherein obtaining information related to Business Strategies and Marketing Strategies further comprises: ensuring reliability and validating expected data metrics of a Business Strategy/Marketing Strategy—based on a self-learning mechanism—by examining their correlation with predefined reference metrics, and fine tuning these values accordingly, thereby ensuring that the current Business Strategy/Marketing Strategy is constantly valid, reliable, efficient and qualitative measurable.

3. A method according to claim 2, further comprising applying artificial intelligent algorithms on the fine-tuned data—as part of the self-learning mechanism—to identify hidden patterns, market trends, marketing, strategic and business insights thereby extracting data of strategic and business values accordingly, and providing valid and reliable Business Strategy/Marketing Strategy.

4. The method according to claim 1, wherein obtaining information related to Business Strategy/Marketing Strategy comprises: performing data mining operations, real-time and offline analyzing, and real-time retrieving of insights from a plurality of sources—in order to collect customer interaction information from multi-source signals.

5. The method according to claim 4, wherein the data mining operations, real-time analyzing, retrieving of insights from a plurality of sources, comprise data retrieval from external sources including Social Media and Professional Databases.

6. The method according to claim 4, wherein the customer interactions comprise at least one of a brand—Product, Solution, or Service—review, a review comment, a post, a comment, various types of digital feedbacks, or interconnected documents and other digital conversations.

7. The method according to claim 4, wherein analyzing the information to identify patterns comprises: identifying parameters based on their current values and computing foreseen values of these parameters, and accordingly providing relevant trends—business, commercial, trade, geo-locational, geographic, demographic, and psychographic—both domestic and international, that may affect the Business Strategy/Marketing Strategy.

8. The method according to claim 7, wherein analyzing the information to identify patterns further comprises: analyzing the parameters at the end of the generating process of the Business Strategy/Marketing Strategy of a specific sector and amending the system predefined reference metrics of this sector accordingly—as known as Post-Mortem Analysis, thereby ensuring validity and reliability.

9. The method according to claim 1, wherein analyzing the information to identify patterns comprises: qualitatively and efficiently identifying a set of influencing parameters, wherein the set of influencing parameters is used by a vendor to define Business Strategies and Marketing Strategies for a set of customers.

10. A method according to claim 1, further comprising allowing the integration of human intuition, expertise, and usable knowledge, and accordingly providing most up-to-date, valid, and reliable Business Strategy/Marketing Strategy.

11. A method according to claim 1, further comprising creating evidence-based, actionable insights to essential business questions, by the data processing and data mining.

12. A method according to claim 11, wherein the creation of the actionable insights includes one or more of: fully-automated and continually gathering information from many sources—both in real time and offline, capturing a 360 degree view around the Product/Solution/Service, monitoring the social conversation surround the brand—Product, Solution, or Service—filtering the top relevant information only, identifying hidden patterns—by analyzing huge amount of information and intelligence, and over long time, in-depth, competitive analysis, continually analyzing/reanalyzing the information, and comparing the results to the real world—ensuring the system is always valid and reliable, micro-assessment of strengths, weaknesses, opportunities, an threats, identifying and alerting vulnerabilities, identifying and alerting edge advantages, minimizing risks and maximizing opportunities by early discovering and alerting, reactive decision making, Post-Mortem analysis—enhancing the validity and reliability of the system, cross-checking with insights generated for other analysis of the same sector and/or country—enhancing the validity and reliability of the system.

13. A method according to claim 2, further comprising providing an operational Reactive Decision Making module while the Business Strategy/Marketing Strategy is running, thereby enabling responding—across all channels—on-the-fly, changing/modifying the Business Strategy/Marketing Strategy in real time, and affecting the results accordingly.

14. A method according to claim 1, wherein fully-automatically and qualitatively defining a Business Strategy/Marketing Strategy based on the selected patterns comprises: dynamically identifying at least one of channels associated with a segment of brands—either Products, Solutions, or Services; identifying Business Strategies and Marketing Strategies of a vendor associated with a segment of brands based on current business, commercial, trade, geo-locational, geographic, demographic, and psychographic factors that are associated with a customer and a most efficient channel to reach the customer for the segment of said brands; and presenting to a client associated with a customer, a set of Business Strategies and Marketing Strategies defined by a vendor for the segment of said brands as a ranked list.

15. A method according to claim 3, further comprising forecasting future outcomes based on hidden patterns and trends—business marketing, commercial, trade, extracting data of strategic and business values accordingly, thereby enabling decision making.

16. A system, comprising:
a) at least one processor; and
b) a memory comprising computer-readable instructions which when executed by the at least one processor causes the processor to execute a data processing system for defining and qualitatively measuring Business Strategies and Marketing Strategies, wherein the system:
dynamically obtains—by a data mining subsystem—information related to a Business Strategy/Marketing Strategy;
analyzes—by a data processing subsystem—said information, in real-time and offline, to identify patterns;
selects—by said data processing subsystem—relevant patterns from said identified patterns to define a Business Strategy/Marketing Strategy for a customer; and
defines—by said data processing subsystem—a Business Strategy/Marketing Strategy based on said selected patterns and addressed to a specific brand—Product, Solution, or Service—of a specific customer, which playing in a specific sector, of a specific country, at a specific time.

17. A non-transitory computer-readable medium comprising instructions which when executed by at least one processor causes the processor to perform the method of claim 1.
